(19) United States
(12) Patent Application Publication
(10) Pub. No.: US 2014/0161712 A1
(43) Pub. Date: Jun. 12, 2014

(54) LOW-TEMPERATURE METHOD AND SYSTEM OF MANUFACTURING SPHEROIDAL GRAPHITE

(71) Applicant: National Tsing Hua University, Hsinchu City (TW)

(72) Inventor: Swe-Kai CHEN, Hsinchu City (TW)

(73) Assignee: National Tsing Hua University, Hsinchu City (TW)

(21) Appl. No.: 14/066,829

(22) Filed: Oct. 30, 2013

(30) Foreign Application Priority Data
Dec. 10, 2012 (TW) 101146459

(51) Int. Cl. C01B 31/04; B01J 8/20

(52) U.S. Cl. CPC C01B 31/04; B01J 8/20
USPC 423/448; 422/140

(57) ABSTRACT

A low-temperature graphite manufacturing method and a system thereof are disclosed. A graphite cast iron smelting manufacturing technique is used for melting a cast iron, for forming a cast iron melt. A graphitizing agent, a nucleating agent, and a spheroidizing agent are continuously added into the cast iron melt, for making the carbon powder be graphitized and spheroidized. Within the cast iron melt, the amounts of the carbon, the graphitizing agent, the nucleating agent, and the spheroidized agent are adjusted for making the spheroidal graphite be able to continuously float out of the cast iron melt. After that, by using gas blowing and electrostatic dust removal, the powdered graphite can be collected. At last, the gases are recycled and the collected powdered graphite is purified by acid pickling.

The current application claims a foreign priority to the patent application of Taiwan No. 101146459 filed on Dec. 10, 2012.

### BACKGROUND OF THE INVENTION

1. Field of the Invention

The present disclosure relates to a low-temperature method and system of manufacturing spheroidal graphite; in particular, to a low-temperature manufacturing technique which adds the carbon powder into the molten cast iron and makes the spheroidal graphite float out of the melt of cast iron bath, for continuously, rapidly, and consistently collecting graphite.

2. Description of Related Art

Presently, most of the electrometallurgy or electrolysis industries use man-made graphite products, the graphitized products. The physical chemistry properties of the graphitized products are much stronger than the nature graphite products. After the high-temperature thermal processes over 2000° C. and even up to 3200° C., the carbon products such as the petroleum coke or the pitch coke can be executed by the graphitizing processes for changing the amorphous carbon into the crystalline graphite. Thus all the conventional methods for manufacturing the graphitized products use the petroleum coke or the pitch coke as the ingredients, in addition, two of them are the materials which can be easily graphitized; thus the qualities of the manufactured graphite products are relatively better.

The pitch coke enters the graphitizing period only when it is heated to over 1700° C., and the petroleum coke enters the graphitizing period only when it is heated to over 2000° C. By experiments, the increasing of the thickness and the width of the graphite crystal grain is obvious when the temperature is over 2000° C., and the temperature needs to reach about 2300° C. for the graphite crystal grains to approximate to the crystal sizes of the nature graphite. The flawless graphitizing needs over 2500° C. Therefore, the actual manufacturing temperature for the graphitized products is practically 2200° C. to 2300° C.

Although the conventional technique for forming spheroidal graphite by graphitizing the petroleum coke or the pitch coke is working for years and has the advantage that the sizes of the crystal grains are controllable, the disadvantage thereof is that the requisite temperature for graphitizing is too high (about 2200° C. to 2300° C.), thus it is extremely hard to design operating graphitization furnace, and the severe environment problem may be likely.

Therefore, the present disclosure is for generating and refining the spheroidal graphite at low temperature. The conventional technique uses the petroleum coke or the pitch coke and requires 2200° C. to 2300° C. for forming relatively better qualities of graphitizing products. The present disclosure uses the materials other than the conventional petroleum coke or the pitch coke, adds the carbon powders into the cast iron melt, and makes the spheroidal graphite float out of the cast iron melt automatically, to generate high quality spheroidal graphite by continuous, rapid, and consistent operations in low temperature environment.

In addition, a study (AFS Trans., Vol. 101 (1993) 447-458.) shows that the following phenomena may make the spheroidal graphite float at the surface of casting foundry goods:

(1) A. P. Druschitz and W. W. Chaput found that if the solidification time is shortened (to about 10 minutes), the floating trend is lowering along with the increasing of the pouring temperature.

(2) When the carbon equivalent is too high, a large amount of graphite is separated from the cast iron melt when the temperature is high. Because the density of the graphite is smaller than the iron, under the driving of the magnesium vapors, the graphite floats to the upper part of the casting foundry goods. When the carbon equivalent is too high, the phenomenon of graphite floating is much more severe. It's worth noting that, the high equivalent of carbon is the main reason of the graphite floating.

(3) Under the situation that the carbon equivalent is constant, the floating trend of the graphite may be lowered by properly reducing the quantity of silicon contained therein.

Therefore, by the catalysis actions of the magnesium and the silicon, the present disclosure may be able to simultaneously spheroidize and graphitize the added carbon powders. We may know from the above study that, in the manufacturing processes, the amount of floating graphite may be increased if the pouring temperature is lowered and the quantity of carbon and silicon is increased.

### SUMMARY OF THE INVENTION

The present disclosure is for providing a low-temperature graphite manufacturing method and a system thereof. The method and system add the carbon powders into the cast iron melt under the low temperature manufacturing processes, and makes the spheroidal graphite float out of the cast iron melt, for continuously, rapidly, and consistently collecting the spheroidal graphite.

The low-temperature manufacturing method which can reaches the aforementioned objectives includes the following steps:

using a graphite cast iron smelting manufacturing technique for melting a cast iron, to form a cast iron melt, and continuously adding a carbon powder into the cast iron melt;

continuously adding a graphitizing agent, a nucleating agent, and a spheroidizing agent into the cast iron melt, wherein the graphitizing agent can make the carbon powder be graphitized, the nucleating agent is for increasing a degree of crystallization of a graphite polymer, and the spheroidizing agent is for spheroidizing graphite;

increasing an amount of carbon in the cast iron melt, and adjusting the amounts of the graphitizing agent, the nucleating agent, and the spheroidizing agent, for making the spheroidal graphite continuously float out of the cast iron melt;

collecting powdered graphite by blowing gases and electrostatic dust removal; and

recycling the gases, and purifying the acquired powdered graphite by acid pickling.

Specifically, the cast iron smelting manufacturing technique is for melting the cast iron by using an induction furnace, a laser, or an electron beam.

Specifically, a range of temperature of the cast iron melt lies between 1500° C. to 1600° C.

Specifically, the smelting process is performed under the temperature range 1500° C. to 1600° C., and after the carbon powder is continuously added into the cast iron melt, the spheroidal graphite is crystallized in the cast iron melt, and after the amounts of the carbon and the silicon is increased, the spheroidal graphite can continuously float out from the cast iron melt.

Specifically, the graphitizing agent is Si, and when the carbon powder is continuously added into the cast iron melt, the graphitizing agent is also added for increasing the amount of silicon in the cast iron melt, to improve the degree of graphitizing of the carbon powder.

Specifically, the nucleating agent is a mixture of SiSr and BiFe.

Specifically, the nucleating agent is a mixture of SiFe and BiFe.

Specifically, the spheroidizing agent is REMg, and when the carbon powder is continuously added into the cast iron melt, the spheroidizing agent is also added for increasing the amount of the magnesium or the rare earth, to make the graphite to spheroidize and generate the spheroid graphite.

Specifically, the purifying is using an acid solution for acid pickling the powdered graphite.

In addition, the low-temperature manufacturing system of a spheroidal graphite according to the present disclosure includes a cast iron molten tank which is separated in the cast iron molten region into a carbon feed region and a graphite collecting region. The bottom of the cast iron molten region includes an incline plane. The cast iron molten region is for melting the cast iron, and for forming a cast iron melt in the cast iron molten region. In addition, the top of the feed region is connected with a feed tuyere, carbon powders and silicon powders are added into the cast iron melt through the feed tuyere. The graphite collecting region includes at least one gas inlet and at least one suction port. The system also includes a gas feeding device, connecting with the gas inlet of the graphite collecting region, for inputting gases into the graphite collecting region, and for blowing the spheroidal graphite powders floating from the cast iron melt. The system also includes a dust collecting device, connecting with the gas feeding device and the suction port. The dust collecting device includes a gas suction device, a filter device, and a gas recycling device. The filter device is disposed between the gas suction device and the gas recycling device. After the gas suction device collects the powdered graphite from the suction port, the gas recycling device can extract and recycle the gases flowing along with the collected powdered graphite. The filter device which is disposed between the gas suction device and the gas recycling device can collect the powdered graphite. The gases extracted by the gas recycling device are inputted into the gas feeding device again. The system also includes an acid pickling device, connecting with the filter device of the dust collecting device. The powdered graphite collected by the filter device can be transmitted to the acid pickling device for doing an acid pickling process.

Specifically, the gas recycling device of the dust collecting device can be connected with the gas feeding device through a gas pipe.

Specifically, a partition plate is disposed between the carbon feed region and the graphite collecting region.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a manufacturing process flow chart of a low-temperature manufacturing method and a system thereof of a spheroidal graphite according to the present disclosure;

FIG. 2 shows a system structure diagram of a low-temperature manufacturing method and a system thereof of a spheroidal graphite according to the present disclosure; and

FIG. 3 shows system equipment schematic diagram of a low-temperature manufacturing method and a system thereof of a spheroidal graphite according to the present disclosure.

### DETAILED DESCRIPTION OF THE PREFERRED EMBODIMENTS

The aforementioned and other technical contents, features, and efficacies are shown in the following detail descriptions of the preferred embodiments along with the referenced figures.

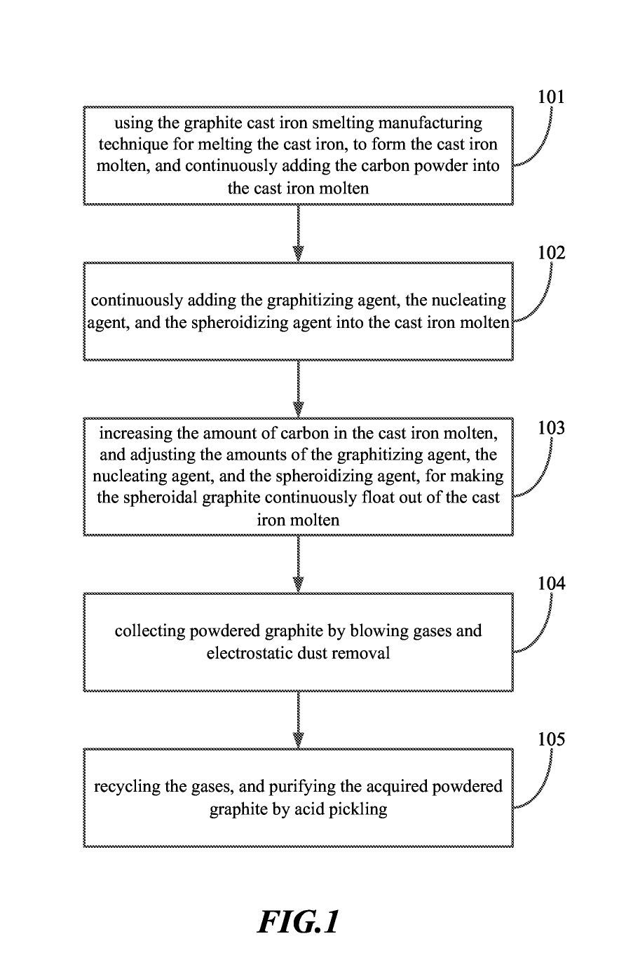

Please refer to FIG. 1 which shows a manufacturing flow chart of a low-temperature manufacturing method of a spheroidal graphite. The steps of the method includes:

1. Using a graphite cast iron smelting manufacturing technique for melting a cast iron, to form a cast iron melt, and continuously adding carbon powders into the cast iron melt 101;

2. Continuously adding a graphitizing agent, a nucleating agent, and a spheroidizing agent into the cast iron melt, wherein the graphitizing agent can make the carbon powder be graphitized, the nucleating agent is for increasing a degree of crystallization of a graphite polymer, and the spheroidizing agent is for spheroidizing the carbon powders 102;

3. Increasing an amount of carbon in the cast iron melt, and adjusting amounts of the graphitizing agent, the nucleating agent, and the spheroidizing agent, for making the spheroidal graphite continuously float out of the molten cast iron 103;

4. Collecting powdered graphite by blowing gases and electrostatic dust removal 104; and

5. Recycling the gases, and purifying the acquired powdered graphite by acid pickling 105.

The graphitizing agent used in the present disclosure is silicon (Si). The nucleating agent is formed by mixing SiSr and BiFe, or SiFe and BiFe master alloys. The spheroidizing agent is REMg. Because silicon is an effective graphite former, which is able to decomposed cementite, the higher the amount of the silicon is, the easier the graphitization is. The spheroidizing agent can make the separated graphite be spheroidized. The spheroidizing agent used in this disclosure is REMg. In the alloy REMg, the magnesium (Mg) is the main spheroidizing element, and the rare earth (RE) is for eliminating the obstacles when performing the spheroidizing process. The rare earth is a very active element which is able to de-oxidize, de-sulfurize, and purify the molten iron, and can neutralize the spheroidizing interference elements. Thus after adding the carbon powder into the cast iron melt, silicon and magnesium can also be added for making the added carbon powder be graphitized and be spheroidized.

In addition, the present disclosure can do the nucleation process twice. In the first time, the mixture of SiSr and BiFe master alloys serves as the nucleating agent for being added into the cast iron melt. In the second time, the mixture of SiFe and BiFe master alloys serves as the nucleating agent for being added into the cast iron melt. Besides increasing the degree of crystallization of the graphite polymer, the first and second times of nucleating processes can also avoid the defects of spheroidizing decay and the reduction of the number of the graphite spheres, etc.

In addition, the study of A. P. Druschitz and W. W. Chaput discover that if the solidification time is shortened, the floating trend of the graphite is lowered along with the increasing of the pouring temperature. At the same time, the floating trend of the graphite is severe when the amounts of the carbon and silicon are too high. Thus, after the spheroidized graphite is formed, because the temperature is relatively low (1500° C. to 1600° C.), if the amounts of the carbon and silicon in the cast iron melt is increased, the spheroidized graphite is able to automatically float on the surface of the cast iron melt. After that, by executing the gas blowing processes (which uses argon or inert gases), the spheroidized graphite can be collected to form the powdered graphite, and then the electrostatic dust removal is executed for separating the powdered graphite and the gas.

At last, the argon or the inert gases are recycled, and the powdered graphite is acid pickled by using acid solution. Thus, the pure spheroidal graphite can be obtained.

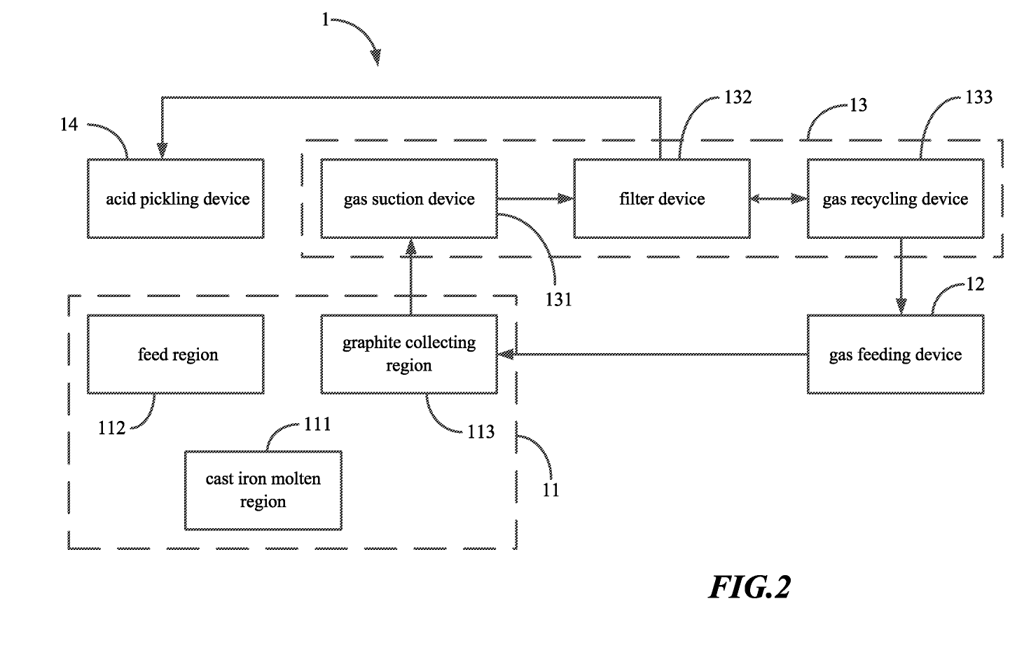

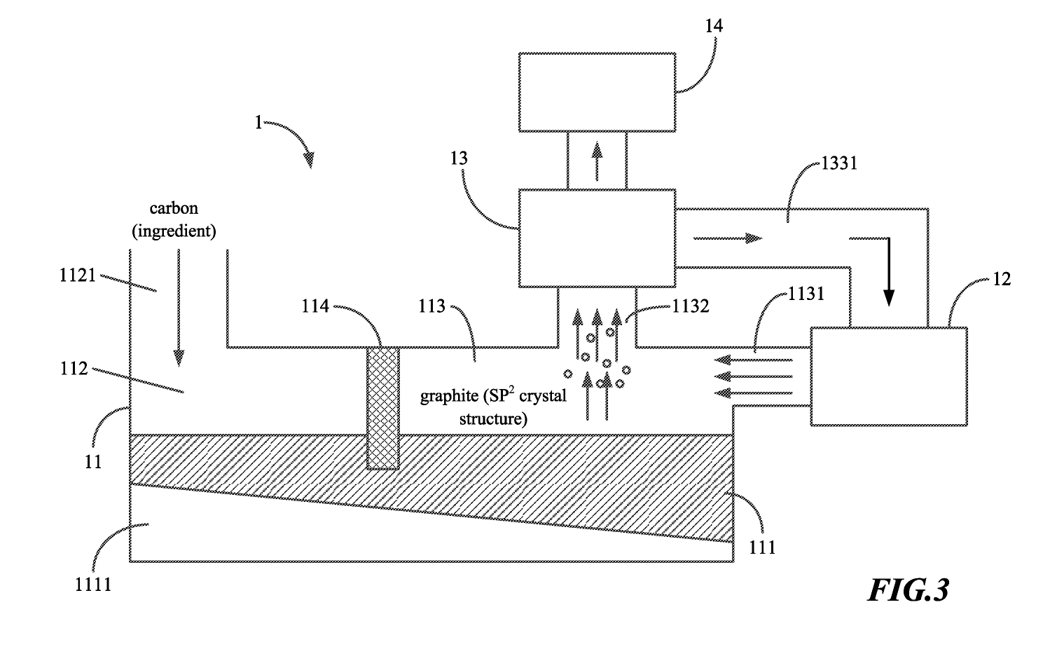

In addition, the low-temperature manufacturing system 1 of a spheroidal graphite according to the present disclosure includes a gas feeding device 12, a dust collecting device 13, and an acid pickling device 14. We may know from FIG. 2 and FIG. 3 that the cast iron molten tank 11 is separated into a cast iron molten region 111, a carbon feed region 112, and a graphite collecting region 113. The bottom of the cast iron molten region 111 includes an inclined plane 1111, and the cast iron molten region 111 is for melting the cast iron, and forming a cast iron melt in the cast iron molten region 111. The top of the carbon feed region 112 is connected with a feed tube 1121, and the carbon powder (ingredients), the graphitizing agent, the nucleating agent, and the spheroidizing agent are added into the cast iron molten bath through the feed tube 1121. The graphite collecting region 113 is disposed with a gas inlet 1131 and at least one suction port 1132.

A partition plate 114 is installed between the carbon feed region 112 and the graphite collecting region 113. Thus when the gas feeding device 12 connecting with the gas inlet 1131 inputs the gases into the graphite collecting region 113 for blowing the spheroidal graphite floating in the cast iron molten bath, the partition plate 114 can be able to avoid the added carbon and silicon powders fly into the graphite collecting region 113, and also can collect the gases inputted by the gas feeding device 12 in the graphite collecting region 113, for forming cyclone phenomenon. Therefore, the spheroidal graphite is blown up and forms the powdered graphite. The powdered graphite has the sp² crystal structure.

After that, the dust collecting device 13 connecting with the suction port 1132 and the gas feeding device 12 collects the powdered graphite, and the dust collecting device 13 has a gas suction device 131, a filter device 132, and a gas recycling device 133. The gas suction device 131 is connecting with the suction port 1132, and the gas recycling device 133 is connecting with the gas feeding device 12 through a gas pipe 1331. The filter device 132 is disposed between the gas suction device 131 and the gas recycling device 133, thus after the gas suction device 131 sucks the powdered graphite through the suction port 1132, the gas recycling device 133 is turned on for recycling the gases used for collecting the powdered graphite. The powdered graphite is remained on the filter device 132, and the gases recycled by the gas recycling device 133 are inputted into the gas feeding device 12 through the gas pipe 1331.

The powdered graphite collected by the filter device 132 is then sent to the acid pickling device 14 connecting with the filter device 132, for executing acid pickling processes.

The low-temperature manufacturing system and method of the spheroidal graphite according to the present disclosure further include the following advantages comparing with the conventional techniques:

1. In the low-temperature manufacturing process of the present disclosure, the carbon powders are added into the cast iron molten bath. By the catalysis of the graphitizing agent, the nucleating agent, and the spheroidizing agent, the carbon powders are graphitized and spheroidized. Thus during the processes of adding the carbon powders, the spheroidal graphite is continuously generated in the cast iron molten bath. After that, by adjusting the content amounts of the carbon, the graphitizing agent, the nucleating agent, and the spheroidizing agent, the spheroidal graphite may be able to automatically float out of the cast iron melt. By the gas blowing process (which uses argon or inert gases) and electrostatic dust removal, the generated graphite can be collected.

2. As compared to the conventional production processes, the present disclosure applies the factors which make the graphite float out during the cast iron smelting processes to become low-temperature graphite production processes.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. A low-temperature manufacturing method of a spheroidal graphite, comprising:
using a graphite cast iron smelting manufacturing technique for melting a cast iron, to form a cast iron melt, and continuously adding a carbon powder into the cast iron molten bath;
continuously adding a graphitizing agent, a nucleating agent, and a spheroidizing agent into the cast iron melt, wherein the graphitizing agent can make the carbon powder be graphitized, the nucleating agent is for increasing a degree of crystallization of a graphite polymer, and the spheroidizing agent is for spheroidizing the graphite powder;
increasing an amount of carbon in the cast iron melt, and adjusting amounts of the graphitizing agent, the nucleating agent, and the spheroidizing agent, for making the spheroidal graphite continuously float out of the cast iron melt;
collecting powdered graphite by blowing gases and electrostatic dust removal; and
recycling the gases, and purifying the acquired powdered graphite by acid pickling.

2. The low-temperature manufacturing method of the spheroidal graphite according to claim 1, wherein the graphite cast iron smelting manufacturing technique is for melting the cast iron by using a induction furnace, a laser, or an electron beam.

3. The low-temperature manufacturing method of the spheroidal graphite according to claim 1, wherein a range of temperature of the cast iron melt lies between 1500° C. to 1600° C.

4. The low-temperature manufacturing method of the spheroidal graphite according to claim 3, wherein the smelting process is executed within 1500° C. to 1600° C., and after the carbon powder is continuously added into the cast iron melt, the spheroidal graphite is crystallized in the cast iron melt, and after the amounts of carbon and silicon is increased, the spheroidal graphite can continuously float out from the cast iron melt.

5. The low-temperature manufacturing method of the spheroidal graphite according to claim 1, wherein the graphitizing agent is Si, and when the carbon powder is continuously added into the cast iron molten, the graphitizing agent is also added for increasing the amount of silicon in the cast iron melt, to improve the degree of graphitizing of the carbon powder.

6. The low-temperature manufacturing method of the spheroidal graphite according to claim 1, wherein the nucleating agent is a mixture of SiSr and BiFe master alloys.

7. The low-temperature manufacturing method of the spheroidal graphite according to claim 1, wherein the nucleating agent is a mixture of SiFe and BiFe master alloys.

8. The low-temperature manufacturing method of the spheroidal graphite according to claim 1, wherein the spheroidizing agent is REMg master alloy, and when the carbon powder is continuously added into the cast iron melt, the spheroidizing agent is also added for increasing the amount of magnesium or rare earth, to make the spheroid graphite.

9. The low-temperature manufacturing method of the spheroidal graphite according to claim 1, wherein purifying by using acid pickling is using an acid solution for acid pickling the powdered graphite.

10. A low-temperature manufacturing system of a spheroidal graphite, comprising:
a cast iron molten tank which is distinguished into a cast iron molten region, a carbon feed region, and a graphite collecting region, wherein the bottom of the cast iron molten region includes an incline plane, and the cast iron molten region is for melting the cast iron, and for forming a cast iron melt in the cast iron molten region, and the top of the feed region is connected with a carbon-feed tube, carbon powders and silicon powders are added into the cast iron melt through the feed tube, and the graphite collecting region includes at least one gas inlet and at least one suction port;
a gas feeding device, connecting with the gas inlet of the graphite collecting region, for inputting gases into the graphite collecting region, to blow the spheroidal graphite floatation from the cast iron melt, in order to form a powdered graphite;
a dust collecting device, connecting with the gas feeding device and the suction port, wherein the dust collecting device includes a gas suction device, a filter device, and a gas recycling device, and the filter device is disposed between the gas suction device and the gas recycling device, after the gas suction device collects the powdered graphite from the suction port, the gas recycling device can extract and recycle the gases flowing along with the collected powdered graphite, and the filter device which is disposed between the gas suction device and the gas recycling device can collect the powdered graphite, and the gases extracted by the gas recycling device are inputted into the gas feeding device again; and
an acid pickling device, connecting with the filter device of the dust collecting device, wherein the powdered graphite collected by the filter device can be transmitted to the acid pickling device for doing an acid pickling process.

11. The low-temperature manufacturing system of the spheroidal graphite according to claim 10, wherein the gas recycling device of the dust collecting device can be connected with the gas feeding device through a gas pipe.

12. The low-temperature manufacturing system of the spheroidal graphite according to claim 10, wherein a partition plate is placed between the feed region and the graphite collecting region.
